(19) United States
(12) Patent Application Publication
(10) Pub. No.: US 2014/0243056 A1
(43) Pub. Date: Aug. 28, 2014

(54) MULTIPLE VIEWPOINT RENDERING METHOD FOR MULTIPLAYER ONLINE GAME AND MULTIPLE VIEWPOINT RENDERING SERVER USING THE SAME

(71) Applicant: Electronics and Telecommunications Research Institute, Daejeon (KR)

(72) Inventors: Dong Chun LEE, Daejeon (KR); Chang Sik CHO, Daejeon (KR); Hun Joo LEE, Daejeon (KR)

(73) Assignee: Electronics and Telecommunications Research Institute, Daejeon (KR)

(21) Appl. No.: 13/967,010

(22) Filed: Aug. 14, 2013

(30) Foreign Application Priority Data
Feb. 27, 2013 (KR) 10-2013-0021397

(51) Int. Cl. A63F 13/30

(52) U.S. Cl. CPC A63F 13/12
USPC 463/1

(57) ABSTRACT

A multiple viewpoint rendering method for a multiplayer online game and a multiple viewpoint rendering server using the same, the multiple viewpoint rendering server including a game progress information receiving unit configured to receive game progress information from an online game server, a viewpoint setting unit configured to obtain viewpoint information corresponding to each of the multiple terminals, a game image rendering unit configured to render game images corresponding to the multiple terminals, respectively, based on the game progress information and the viewpoint information, and a rendered image providing unit configured to provide the multiple terminals with the rendered game images corresponding to the multiple terminals, respectively.

### CLAIM FOR PRIORITY

This application claims priority to Korean Patent Application No. 2013-0021397 filed on Feb. 27, 2013 in the Korean Intellectual Property Office (KIPO), the entire contents of which are hereby incorporated by reference.

### BACKGROUND

1. Technical Field

Example embodiments of the present invention relate in general to the field of online games, and more particularly, to a multiple viewpoint rending method for playing a multiplayer online game, in which many game players simultaneously play the game, on various types of terminals, a configuration of a server for the same, and a configuration of a terminal for the same.

2. Related Art

A multiplayer online game represents an online game which many players join in a three-dimensional virtual space. Examples are a multiplayer First Peron Shooting (FPS) game of the first-person viewpoint and a Massive Multiplayer online role-playing game (MMORPG).

Such a multiplayer online game is provided such that a game scene is shown as a single game scene on a personal terminal (PC, a notebook computer, a smart phone, and the like) of a player (a user), and the player enjoys the game while viewing the game scene.

In general, the multiplayer online game is embodied with detailed graphics and 3D modeling to provide a user with realistic game environments, and thus requires a terminal having a high-performance Central Processing Unit (CPU) and/or Graphics processing unit (GPU) for a user to join the multiplayer online game.

Accordingly, the price of the terminal is increased, and a relatively high power consumption of the multiplayer online game shortens the duration of a battery. In result, the range of object terminals capable of joining a multiplayer online game is reduced.

### SUMMARY

Accordingly, example embodiments of the present invention are provided to substantially obviate one or more problems due to limitations and disadvantages of the related art.

Example embodiments of the present invention provide a method of operating a multiple viewpoint rendering server for providing terminals that join a multiplayer online game with a rendered game image by performing rendering while communicating with an online game server, instead of having the terminals perform the rendering.

Example embodiments of the present invention also provide a configuration of a multiple viewpoint rendering server for providing terminals that join a multiplayer online game with a rendered game image by performing rendering while communicating with an online game server, instead of having the terminals perform the rendering.

Example embodiments of the present invention also provide a method of operating a terminal that interoperates with a multiple viewpoint rendering server for providing terminals that join a multiplayer online game with a rendered game image by performing rendering while communicating with an online game server, instead of having the terminals perform the rendering.

Example embodiments of the present invention also provide a configuration of a terminal that interoperates with a multiple viewpoint rendering server for providing terminals that join a multiplayer online game with a rendered game image by performing rendering while communicating with an online game server, instead of having the terminals perform the rendering.

In some example embodiments, an online game-multiple viewpoint rendering method for providing rendered game images to multiple terminals which join a multiplayer online game includes receiving game progress information from an online game server; obtaining viewpoint information corresponding to each of the multiple terminals; rendering game images corresponding to the multiple terminals, respectively, based on the game progress information and the viewpoint information; and providing the multiple terminals with the rendered game images corresponding to the multiple terminals, respectively.

The game progress information may include information about a three-dimensional game space of the multiplayer online game and attribute information of objects existing in the game space.

The online game-multiple viewpoint rendering method may further include generating a multiplayer image, which is composed of the rendered game images corresponding to the multiple terminals, respectively, in the form of tiles. The online game-multiple viewpoint rendering method may further include outputting the multiplayer image.

The viewpoint information may be received from the online game server or each of the multiple terminals.

The viewpoint information may be generated based on the game progress information received from the online game server.

In other example embodiments, an online game-multiple viewpoint rendering server for providing rendered game images to multiple terminals which join a multiplayer online game includes a game progress information receiving unit, a viewpoint setting unit, a game image rendering unit, and a rendered image providing unit. The game progress information receiving unit may be configured to receive game progress information from an online game server. The viewpoint setting unit may be configured to obtain viewpoint information corresponding to each of the multiple terminals. The game image rendering unit may be configured to render game images corresponding to the multiple terminals, respectively, based on the game progress information and the viewpoint information. The rendered image providing unit may be configured to provide the multiple terminals with the rendered game images corresponding to the multiple terminals, respectively.

The game progress information may include information about a three-dimensional game space of the multiplayer online game and attribute information of objects existing in the game space.

The game image rendering unit may generate a multiplayer game image, which is composed of the rendered game images corresponding to the multiple terminals, respectively, in the form of tiles. The online game-multiple viewpoint rendering server may further include an image output unit configured to output the multiplayer game image through a display device.

The viewpoint information setting unit may receive the viewpoint information from the online game server or each of the multiple terminals.

The viewpoint setting unit may generate the viewpoint information based on the game progress information received from the online game server.

In still other example embodiments, a terminal that participates in a multiplayer online game includes a user input interface unit, a game progress manipulation unit, a rendered image receiving unit and a game image output unit. The game progress manipulation unit may be configured to generate game progress manipulation information based on user input through the user input interface unit, and provide an online game server or a multiple viewpoint rendering server with the game progress manipulation information. The rendered image receiving unit may be configured to receive a game image rendered from a viewpoint of the user from the multiple viewpoint rendering server. The game image output unit may be configured to output the rendered game image received by the rendered image receiving unit.

The game progress manipulation information may include information about movement of an object corresponding to the user or information about change in the viewpoint of the user.

The rendered image receiving unit may receive a multiplayer game image having game images, which are rendered corresponding to multiple terminals including the terminal, respectively, composed in the form of tiles, from the multiple viewpoint rendering server, and the game image output unit may output the multiplayer game image.

As is apparent above, by using the multiple viewpoint rendering method or server in accordance with the present invention, a multiplayer online game can be run on a terminal having a relatively low performance.

In addition, by using the multiple viewpoint rendering method or server in accordance with the present invention, a terminal can receive a multiplayer game image that enables checking of game scenes of many terminals which join a game as well as its own game scene.

In addition, a terminal with relatively low computing power and limited power can join a multiplayer online game, thereby broadening the range of object terminals capable of joining an online game. In particular, since terminal hardware for a multiplayer online game is implemented in an independent form, the same online game can be executed on various terminals, regardless of terminal platform.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view illustrating an online game environment to which a multiple viewpoint rendering method or a multiple viewpoint rendering server in accordance with the present invention may be applied.

FIG. 2 is a flowchart illustrating an operation process of a general multiplayer online game.

FIG. 3 is a conceptual view illustrating an online game environment to which a multiple viewpoint rendering server in accordance with the present invention is applied. to FIG. 4 is a conceptual view illustrating a multiplayer game image provided by the multiple viewpoint rendering server in accordance with the present invention.

FIG. 5 is a block diagram illustrating an example embodiment of a configuration of the multiple viewpoint rendering server in accordance with the present invention.

FIG. 6 is a block diagram illustrating an example embodiment of a configuration of a terminal that interoperates with the multiple viewpoint rendering server in accordance with the present invention.

FIG. 7 is a flowchart illustrating an example embodiment of the multiple viewpoint rendering method in accordance with the present invention.

FIG. 8 is a flowchart illustrating another example embodiment of the multiple viewpoint rendering method in accordance with the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

A Multiplayer Online Game Environment

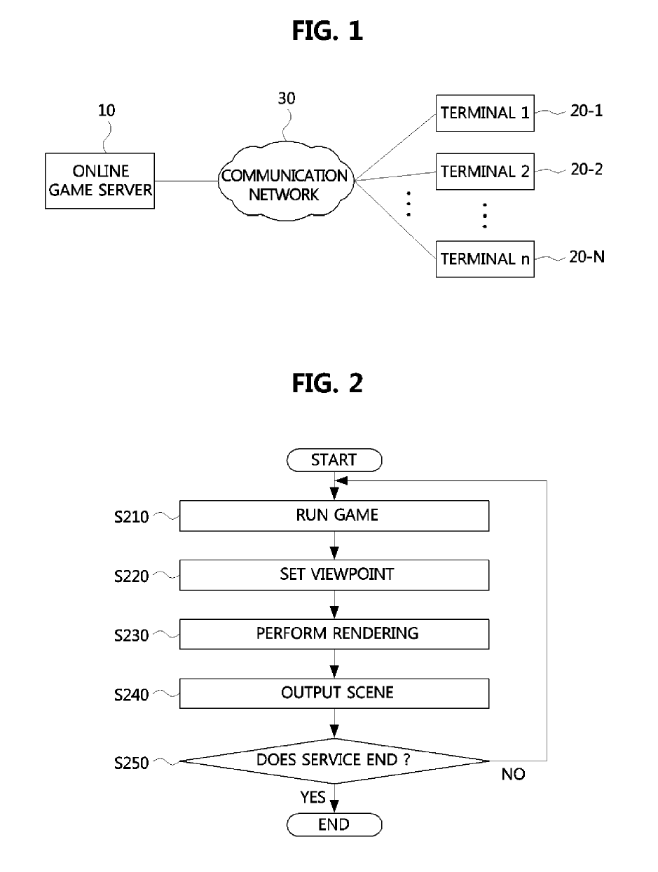

FIG. 1 is a conceptual view illustrating an online game environment to which a multiple viewpoint rendering method or a multiple viewpoint rendering server in accordance with the present invention may be applied.

Referring to FIG. 1, a multiplayer online game environment includes an online game server 10, multiple terminals 20-1, . . . and 20-N used by multiple players, and a communication network 30 connecting the online game server 10 to the terminals 20-1, . . . and 20-N, such as the Internet, a local area network, and a cellular mobile communication network.

In general, the online game server 10 provides a virtual space for an online game, and manages attributes (various attributes such as shape, state, position, movement, and experience) of all objects exiting in the virtual space, and updates the attributes of the objects according to interaction with the players and according to time. The terminals 20-1, . . . and 20-N receive information about the virtual space provided by the online game server 10 and the attributes of the objects from the online game server 10, and render the virtual space and the objects from a viewpoint of a player corresponding to each of the terminals 20-1, . . . and 20-N to output the result of rendering to a display device provided on the terminals 20-1, . . . and 20-N.

Meanwhile, the online game may be a three-dimensional game which multiple players may join in a three-dimensional virtual space, such as a First Person Shooting (FPS) game and a Massive Multiplayer online role-playing game (MMORPG) game.

FIG. 2 is a flowchart illustrating an operation process of a general multiplayer online game.

Referring to FIG. 2, an operation process of a general multiplayer online game includes running a game (S210), setting a viewpoint (S220), performing rendering (S230), outputting a scene (S240), and checking whether a service ends (S250).

First, in the running of the game 5210, a virtual space provided by a game and attributes of all objects in the virtual space are updated according to interaction between the online game server 10 and the terminals 20-1, . . . and 20-N corresponding to players, respectively. For example, in the running of the game 5210, the terminals 20-1, . . . and 20-N receive user inputs that command movements of objects corresponding to the players through a user interface device (a touch screen, a keyboard, a mouse, and a joystick) provided on the terminals, and provide the received user inputs to the online game server 10, and the online game server 10 updates the virtual space and the attributes of the objects in accordance with the user inputs provided from all terminals.

In the setting of the viewpoint S220, a viewpoint of a player corresponding to each terminal with respect to the virtual space is set. The setting of the viewpoint may be regarded as a concept of locating a camera in accordance with the position and a viewing angle of a player object in a three-dimensional space. In this case, the viewpoint of a player object corresponding to each terminal with respect to the virtual space may be determined by the interaction between the terminals 20-1, . . . and 20-N and the online game server 10, a command input from the terminals 20-1, . . . and 20-N (for example, a command of movement), and a decision made by the online game server 10.

In the rendering of the scene S230, a game scene to be output through each terminal is rendered based on the virtual space and the attributes of the objects that are determined in the running of the game S220, according to the viewpoint determined in the setting of the viewpoint S220. In the recent trend of the online game, high-resolution and high-quality graphics operations are required, and thus in general, the rendering of a scene is performed by a central processing unit (CPU) and/or a graphics processing unit (GPU) provided in each terminal.

In the outputting of the scene S240, a game scene from a viewpoint of each player rendered in the rendering of the scene S230 is output through a display device provided in each terminal.

In the checking whether the service ends S250, if a request is made by a player, the game ends, and if no request is made by a player, the operation returns to the running of the game S210 to update the movements of all objects appearing in the game, thereby continuing playing of the game.

Meanwhile, in the above described online game environment, each terminal performs a considerable amount of computation, and thus requires a powerful CPU and/or GPU. Accordingly, the cost of the terminal is increased, the duration of a battery is reduced, and the types of terminals capable of joining the online game are limited.

Configurations of a Multiple Viewpoint Rendering Server and a Terminal in Accordance with an Example Embodiment of the Present Disclosure

With ongoing development and performance enhancement of computing devices, there have been an increasing number of attempts to provide a plurality of input/output devices (a monitor, a keyboard and a mouse) in a single computing device, for example, a personal computer (PC), and share the single PC.

The present invention provides a multiple viewpoints rendering method performed on such a high-performance computing device. As such, in an environment to which the present invention is applied, terminals may each be embodied to only receive and display a rendering result provided from the high-performance computing device, and may each have a relatively low performance compared to the terminals 20-1, . . . and 20-N described above.

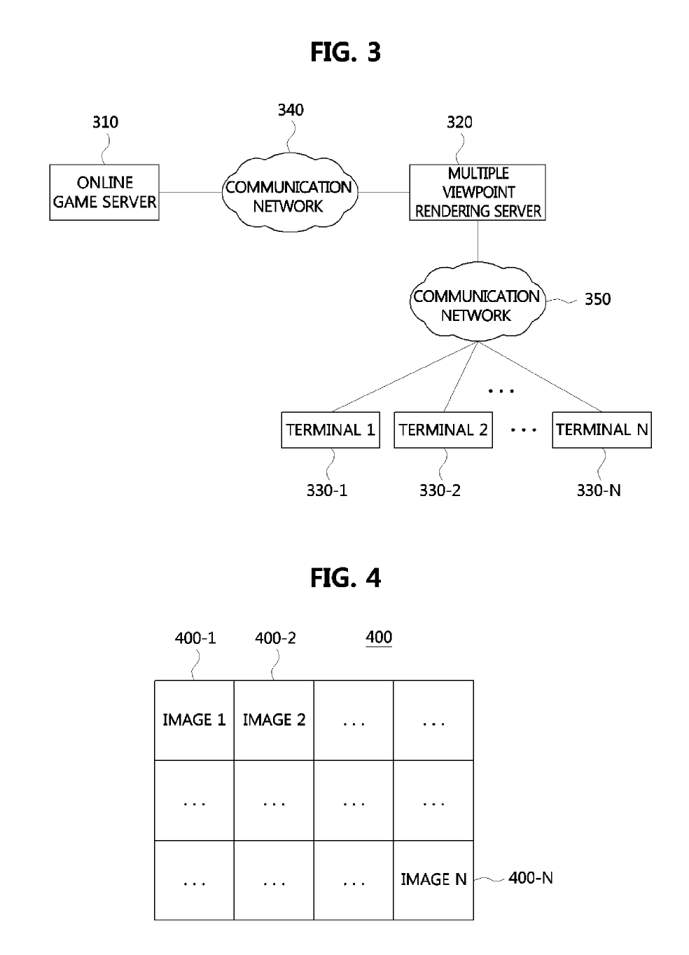

FIG. 3 is a conceptual view illustrating an online game environment to which a multiple viewpoint rendering server in accordance with the present invention is applied.

Referring to FIG. 3, an online game environment to which a multiple viewpoint rendering server in accordance with an example embodiment is applied includes an online game server 310, a multiple viewpoint rendering server 320, terminals 330-1, . . . and 330-N, a communication network 340 connecting the online game server 310 to the multiple viewpoint rendering server 320, and a communication network 350 connecting the multiple viewpoint rendering server 320 to the terminals 330-1, . . . and 330-N, for example, the Internet, a local area network, and a cellular mobile communication network.

The online game server 310 illustrated in FIG. 3 is an element corresponding to the online game server 10 illustrated in FIG. 1. The online game server 310 of FIG. 3 may have the same configuration as the online game server 10 of FIG. 1, but has a difference with the online game server 10 of FIG. 1 in that the online game server 310 is connected to the terminals 330-1, . . . and 330-N via the multiple viewpoint rendering server 320.

The multiple viewpoint rendering server 320 renders a game image from a viewpoint of each player of each of the terminals 330-1, . . . and 330-N, and transmits the rendered game images to the terminals 330-1, . . . and 330-N, respectively.

Meanwhile, the multiple viewpoint rendering server 320 may form a multiplayer game image. For example, the multiple viewpoint rendering server 320 may be configured to generate an image composed of rendered game images, which are provided to the respective terminals 330-1, . . . and 330-N, in the form of tiles, and output the generated image through a display device provided on the multiple viewpoint rendering server 320.

In addition, the multiple viewpoint rendering server 320 may provide the online game server 300 or at least some of the terminals 330-1, . . . and 330-N with the multiplayer game image upon request. Such a multiplayer game image may be exploited to monitor a game situation and a motion situation at each terminal.

FIG. 4 is a conceptual view illustrating a multiplayer game image provided by the multiple viewpoint rendering server in accordance with the present invention.

Referring to FIG. 4, a multiplayer game image 400 generated by the multiple viewpoint rendering server 320 includes partial image tiles 400-1, . . . and 400-N respectively corresponding to the rendered game images of the terminals 330-1, . . . and 330-N. In this case, the game image included in each tile may be a reduced-resolution image, compared to the rendered game image that is provided to each terminal in practice.

For example, a tile 400-1 includes a game image corresponding to a first terminal 330-1, and a tile 400-2 includes a game image corresponding to a second terminal 330-2. A tile 400-N includes a game image corresponding to a N^{th} terminal 330-N.

Meanwhile, the multiplayer game image illustrated in FIG. 4 includes rendered game images of all terminals 330-1, . . . and 330-N connected to the multiple viewpoint rendering server, but according to a setting of an administrator or a request of a terminal user, may only include a game image of a terminal desired by the administrator or the terminal user.

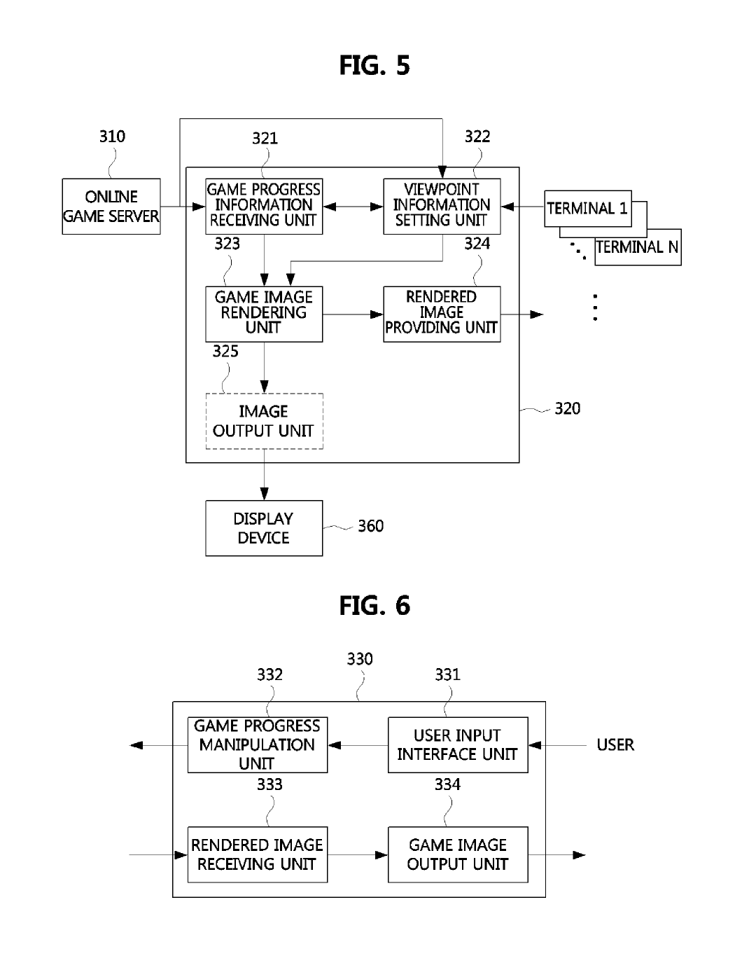

FIG. 5 is a block diagram illustrating an example embodiment of a configuration of the multiple viewpoint rendering server in accordance with the present invention.

Referring to FIG. 5, an example embodiment of the multiple viewpoint rendering server 320 in accordance with the present disclosure is the multiple viewpoint rendering server described above with reference to FIG. 3 to provide rendered game images to the multiple terminals which join the multiplayer online game, and includes a game progress information receiving unit 321, a viewpoint information setting unit 322, a game image rendering unit 323, and a rendered image providing unit 324.

The game progress information receiving unit 321 is an element configured to receive game progress information from the online game server 310. The game progress information may include information about a three-dimensional game space of the multiplayer online game, and information about attributes (various attributes such as shape, state, position, movement, and experience) of all objects exiting in the game space. The game progress information represents information that is updated by the online game server 310 based on game progress manipulation information input from the terminals 330-1, . . . and 330-N.

The viewpoint information setting unit 322 is an element configured to obtain viewpoint information corresponding to each of the multiple terminals 330-1, . . . and 330-N.

That is, the viewpoint information setting unit 322 is an element configured to set a viewpoint of a user corresponding to each terminal with respect to a virtual space of an online game, and serves to set a viewpoint of an object that is used to locate a camera in accordance with the position and the viewing angle of the player object in the three-dimensional virtual space.

In this case, the viewpoint information setting unit 322 may directly receive information about a viewpoint of a user from the multiple terminals 330-1, . . . and 330-N, or receive information about a viewpoint of a user, which is determined by the online game server 310 through the interaction with the terminals, from the online game server 310. In addition, the viewpoint information setting unit 322 may be configured to determine information about a viewpoint of a user based on the game progress information received by the game progress information receiving unit 321 described above.

The game image rendering unit 323 is an element configured to render game images corresponding to the multiple terminals 330-1, . . . and 330-N, respectively, based on the game progress information received by the game progress information receiving unit 321 and the user viewpoint information obtained by the viewpoint information setting unit 322.

The game image rendering unit 323 may render game images for each of multiple terminals 330-1, . . . and 330-N by use of a CPU or a GPU. The computing power of the game image rendering unit 323 may be provided in varying degrees depending on an online game to be rendered (the complexity of a virtual space model, the complexity of an object model in a virtual space, a resolution/color depth of a texture, and the number of objects). In general, the game image rendering unit 323 may be preferably provided with computing power that exceeds a rendering capability of the general terminals 20-1, . . . and 20-N.

In addition, the game image rendering unit 323 may generate a multiplayer game image composed of partial image tiles corresponding to rendered game images of the terminals, respectively. The concept of the multiplayer game image has been described with reference to FIG. 4 above and will not be described again here.

The rendered image providing unit 324 provides the rendered game image of each of the terminals rendered by the game image rendering unit 323 to the corresponding terminal. In this case, since the rendered game image is a result that has been already rendered by the game image rendering unit 323, the rendered image providing unit 324 may be configured to provide each terminal with a compressed game image by use of a moving picture compression technique. In this case, the rendered image providing unit 324 may include an encoder capable of encoding the rendered game image.

The multiple viewpoint rendering server 320 may include, as an additional element, an image output unit 325, and the image output unit 325 may be configured to output a rendered game image of a selected terminal, or to output a multiplayer game image composed of rendered game images of selected terminals, by use of a display device 360.

FIG. 6 is a block diagram illustrating an example embodiment of a configuration of a terminal that interoperates with the multiple viewpoint rendering server in accordance with the present invention.

Referring to FIG. 6, the terminal 330 interoperating with the multiple viewpoint rendering server in accordance with the present disclosure includes a user input interface unit 331, a game progress manipulation unit 332, a rendered image receiving unit 333, and a game image output unit 334.

First, the game progress manipulation unit 332 is an element configured to generate game progress manipulation information based on user input through the user input interface unit 331, and to provide the generated game progress operation information to an online game server or a multiple viewpoint rendering server. The user input interface unit 331 may be embodied as various user input devices, including a touch screen, a keyboard, a joystick, a mouse, and a microphone.

The game progress manipulation information includes information about movement of an object corresponding to a user of each terminal or information about change in the viewpoint of the user, and is required to update the game progress information (information about a game space and information about attributes of objects existing in the game space) described above. In this case, the game progress manipulation information may be directly transmitted from the terminal to the online game server 310, or transmitted to the online game server 310 via the multiple viewpoint rendering server 320.

Based on the information about the change from the user viewpoint included in the game progress manipulation information, the online game server and the multiple viewpoint rendering server determines a viewpoint of a user, and based on the determined viewpoint of the user, the multiple viewpoint rendering server renders a game image corresponding to each user.

The rendered image receiving unit 333 is an element configured to receive a game image that is rendered from the user viewpoint by the multiple viewpoint rendering server 320. As described above, the game image received by the rendered image receiving unit 333 is an image already rendered by the multiple viewpoint rendering server, and thus may be compressed by various moving picture compression techniques.

The game image output unit 334 is an element configured to output a rendered game image received by the rendered image receiving unit 333, through a display device that is provided inside or outside the terminal 330. In a case in which the rendered game image is provided in a form compressed by a moving picture compression technique, the game image output unit 334 may include a decoder capable of decoding the compressed game image.

A Multiple Viewpoint Rendering Method in Accordance with an Example Embodiment

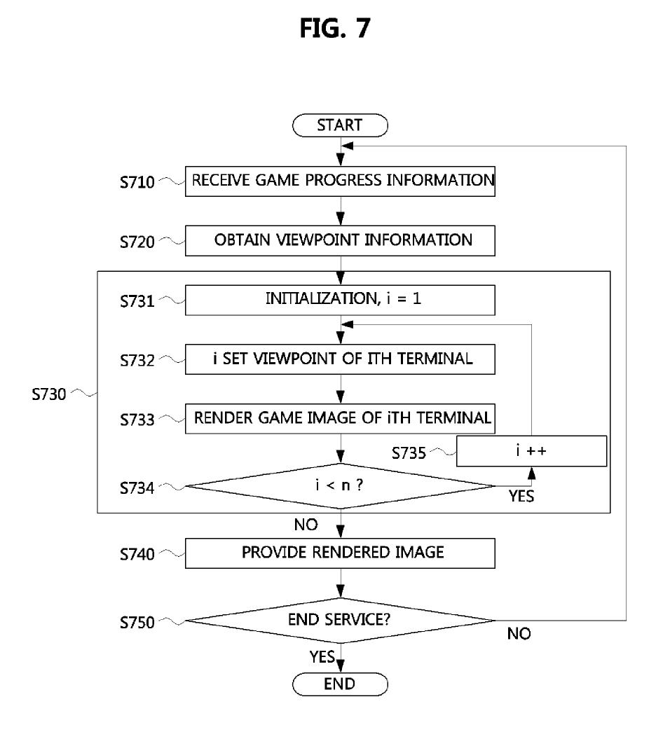

FIG. 7 is a flowchart illustrating an example embodiment of the multiple viewpoint rendering method in accordance with the present invention.

Referring to FIG. 7, a multiple viewpoint rendering method includes receiving game progress information from an online game server (S710), obtaining information about a viewpoint corresponding to each of multiple terminals (S720), rendering game images corresponding to the multiple terminals, respectively, based on the game progress information and the viewpoint information (S730), providing the game images, which are rendered for the multiple terminals, respectively, to the multiple terminals, respectively (S740), and checking whether a service ends (S750).

The receiving of game progress information S710 represents receiving game progress information from an online game server, in which game progress information updated through interaction between the online game server 310 and the terminals 330-1, . . . and 330-N corresponding to players is received. As described above, the game progress information may include information about a three-dimensional game space of the multiplayer online game, and information about attributes (various attributes such as shape, state, position, movement, and experience) of all objects exiting in the game space.

The obtaining of information about a viewpoint corresponding to each of multiple terminals S720 represents setting a viewpoint of an object used to locate a camera in accordance with the position and a viewing angle of a player object in a game space. Information about a viewpoint of a user may be received from the terminals. Alternatively, information about a viewpoint of a user determined by the online game server through interaction with the terminal may be received from the online game server.

The rendering of the game image S730 represents rendering a game image corresponding each of the multiple terminals, based on the game progress information and the information about the viewpoint of the user. The rendering of the game image S730 may be performed by use of a CPU or a GPU with relatively high performance.

As an example, the rendering of the game image S730 may be achieved in a time divisional process, which is different from a case of performing the rendering at the individual terminal described with respect to FIG. 1.

In an initialization stage (S731), i=1 is set in order to repeatedly output a game scene n times, and in an i^{th} camera setting stage (S732), the position of a camera of a game played by an i^{th} user is located in three-dimensional space. In an i^{th} scene rendering stage (S733), a single game scene is completed by outputting all objects appearing in the game. Thereafter, in a determination stage (S734), i<n is determined, and if i is smaller n, i is increased by 1 (S735), and an operation mode returns to the camera setting stage S732 and continues the following stages. If it is determined in the determination stage S734 that i is equal to n, the rendering of game images of all players is regarded as completed, and the operation moves on to a rendered image providing stage (S740).

The rendered image providing stage S740 represents providing the multiple terminals with the game images rendered for the multiple terminals, respectively. In the rendered image providing stage S740, the game images of the terminals rendered in the rendering of the game image S730 are provided to the corresponding terminals. Since the rendered game image is a result of the rendering, the rendered image providing stage S740 may be configured to provide each terminal with a game image compressed by a moving picture compression technique. In this case, the rendered image providing stage S740 may include encoding the rendered game image.

The multiple viewpoint rendering method in accordance with the present invention may further include generating a multiplayer image composed of rendered game images corresponding to the multiple terminals, respectively, in the form of tiles, and outputting the multiplayer image.

In the checking whether a service ends S750, if a request for ending is made by a player, a game service ends, and if no request for ending is made, the operation mode returns to the receiving of the game progress information S710 to update movements of all objects appearing in the game, to continue the game play.

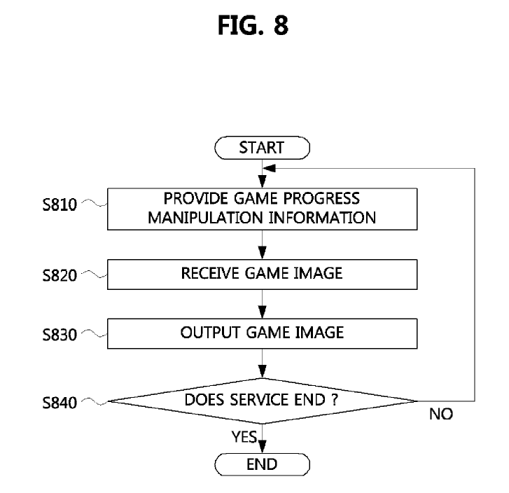

FIG. 8 is a flowchart illustrating another example embodiment of the multiple viewpoint rendering method in accordance with the present invention.

FIG. 8 illustrates another example embodiment of the multiple viewpoint rendering method in accordance with the present invention, representing an operation method of a terminal that operates in response to the multiple viewpoint rendering server described above.

Referring to FIG. 8, the multiple viewpoint rendering method in accordance with the present disclosure includes generating, by a terminal, game progress manipulation information based on user input through a user input interface device, and providing the generated game progress manipulation to an online game server or a multiple viewpoint rendering server (S810), receiving a game image rendered from a viewpoint of a user from the multiple viewpoint rendering server (S820), and outputting the received rendered game image (S830).

Operation 810 represents generating game progress manipulation information based on the user input through the user interface device, and providing the game progress manipulation information to the online game server or the multiple viewpoint rendering server.

The game progress manipulation information includes information about movement of an object corresponding to a user of each terminal or information about change in the viewpoint of the user, and is required to update the game progress information (information about a game space and information about attributes of objects existing in the game space). In operation 810, the game progress manipulation information may be directly transmitted to the online game server, or transmitted to the online game server via the multiple viewpoint rendering server 320.

Operation 820 represents receiving a game image rendered from a viewpoint of a user from the multiple viewpoint rendering server, and as described above, the game image received by the terminal in accordance with the present disclosure is an image already rendered by the multiple viewpoint rendering server, and thus may be provided in a compressed form by various moving picture compression techniques.

Operation 830 represents outputting a game image received in operation 820 through a display device that is provided inside or outside the terminal. In a case in which the rendered game image is provided in a form compressed by a moving picture compression technique, operation 830 may include decoding the compressed game image.

While example embodiments of the present invention and their advantages have been described in detail, it should be understood that various changes, substitutions and alterations may be made herein without departing from the scope of the invention.

What is claimed is:

1. An online game-multiple viewpoint rendering method for providing rendered game images to multiple terminals which join a multiplayer online game, the online game-multiple viewpoint rendering method comprising:
receiving game progress information from an online game server;
obtaining viewpoint information corresponding to each of the multiple terminals;
rendering game images corresponding to the multiple terminals, respectively, based on the game progress information and the viewpoint information; and
providing the multiple terminals with the rendered game images corresponding to the multiple terminals, respectively.

2. The online game-multiple viewpoint rendering method of claim 1, wherein the game progress information comprises information about a three-dimensional game space of the multiplayer online game and attribute information of objects existing in the game space.

3. The online game-multiple viewpoint rendering method of claim 1, further comprising:
generating a multiplayer image, which is composed of the rendered game images corresponding to the multiple terminals, respectively, in the form of tiles.

4. The online game-multiple viewpoint rendering method of claim 3, further comprising:
outputting the multiplayer image.

5. The online game-multiple viewpoint rendering method of claim 1, wherein the viewpoint information is received from the online game server or each of the multiple terminals.

6. The online game-multiple viewpoint rendering method of claim 1, wherein the viewpoint information is generated based on the game progress information received from the online game server.

7. The online game-multiple viewpoint rendering method of claim 1, wherein the multiplayer online game is a multiplayer First Person Shooting (FPS) game or a Massive Multiplayer online role-playing game (MMORPG) game.

8. An online game-multiple viewpoint rendering server for providing rendered game images to multiple terminals which join a multiplayer online game, the online game-multiple viewpoint rendering server comprising:
a game progress information receiving unit configured to receive game progress information from an online game server;
a viewpoint setting unit configured to obtain viewpoint information corresponding to each of the multiple terminals;
a game image rendering unit configured to render game images corresponding to the multiple terminals, respectively, based on the game progress information and the viewpoint information; and
a rendered image providing unit configured to provide the multiple terminals with the rendered game images corresponding to the multiple terminals, respectively.

9. The online game-multiple viewpoint rendering server of claim 8, wherein the game progress information comprises information about a three-dimensional game space of the multiplayer online game and attribute information of objects existing in the game space.

10. The online game-multiple viewpoint rendering server of claim 8, wherein the game image rendering unit generates a multiplayer game image, which is composed of the rendered game images corresponding to the multiple terminals, respectively, in the form of tiles.

11. The online game-multiple viewpoint rendering server of claim 10, further comprising an image output unit configured to output the multiplayer game image through a display device.

12. The online game-multiple viewpoint rendering server of claim 8, wherein the viewpoint information setting unit receives the viewpoint information from the online game server or each of the multiple terminals.

13. The online game-multiple viewpoint rendering server of claim 8, wherein the viewpoint setting unit generates the viewpoint information based on the game progress information received from the online game server.

14. The online game-multiple viewpoint rendering server of claim 8, wherein the multiplayer online game is a multiplayer First Person Shooting (FPS) game or a Massive Multiplayer online role-playing game (MMORPG) game.

15. A terminal that participates in a multiplayer online game, the terminal comprising:
a user input interface unit;
a game progress manipulation unit configured to generate game progress manipulation information based on user input through the user input interface unit, and provide an online game server or a multiple viewpoint rendering server with the game progress manipulation information;
a rendered image receiving unit configured to receive a game image rendered from a viewpoint of the user from the multiple viewpoint rendering server; and
a game image output unit configured to output the rendered game image received by the rendered image receiving unit.

16. The terminal of claim 15, wherein the game progress manipulation information comprises information about movement of an object corresponding to the user or information about change in the viewpoint of the user.

17. The terminal of claim 15, wherein the rendered image receiving unit receives a multiplayer game image having game images, which are rendered corresponding to multiple terminals including the terminal, respectively, composed in the form of tiles, from the multiple viewpoint rendering server, and the game image output unit outputs the multiplayer game image.
